(19) United States
(12) Patent Application Publication
(10) Pub. No.: US 2013/0036639 A1
(43) Pub. Date: Feb. 14, 2013

(54) Commercial signs including magnetic components incorporating replaceable messages

(71) Applicant: John Bowman, St. John, IN (US)

(72) Inventor: John Bowman, St. John, IN (US)

(21) Appl. No.: 13/573,707

(22) Filed: Oct. 3, 2012

Related U.S. Application Data
(63) Continuation of application No. 13/013,644, filed on Jan. 25, 2011.
Application No. 13/013,644 is a continuation of application No. 13/200,665, filed on Sep. 28, 2011.
Application No. 13/200,665 is a continuation of application No. 13/013,644, filed on Jan. 25, 2011.
(60) Provisional application No. 61/301,922, filed on Feb. 5, 2010.
(60) Provisional application No. 61/301,922, filed on Feb. 5, 2010.

(51) Int. Cl. G09F 7/04; G09F 15/00

(52) U.S. Cl. 40/600

(57) ABSTRACT

A sign utilizing interchangeable, replaceable magnetic displays adhering to a ferromagnetic layer. The information, printed on the magnetic layers, retains their original freshness and crispness until removed and their replacements installed in their stead. Installing the new magnetic displays proves very facile and only requires removing the old magnetic display from its smooth, ferromagnetic panel and placing the new magnetic sign in its stead. The ferromagnetic panels can sit on top of regular signs which may include translucent panels with information visible through the panels. The ferromagnetic panel can clamp onto the regular sign since it requires no internal lighting. This arrangement avoids the need to penetrate any surface of the nonmagnetic sign. The ferromagnetic panel may have a nonflat configuration, and the magnetic sheet a flexibility to adhere intimately to the panel. The magnetic sign may, in fact, include several sections for flexibility in the sign's installation and content.

### CROSS-REFERENCE TO RELATED APPLICATIONS

The present application constitutes (1) a continuation of the U.S. patent application Ser. No. 13/013,644, filed on Jan. 25, 2011, which claims the benefit of the filing of the U.S. provisional patent application No. 61/301,922, filed on Feb. 5, 2010, and (2) a continuation of the U.S. patent application Ser. No. 13/200,665, filed on Sep. 28, 2011, which itself constitutes a continuation of the U.S. patent application Ser. No. 13/013,644, filed on Jan. 25, 2011, which claims the benefit of the filing of the U.S. provisional patent application No. 61/301,922, filed on Feb. 5, 2010

### BACKGROUND

(1) Field of the Invention

The present invention relates generally to signs exhibiting information for commercial enterprises. More particularly, it involves signs that permit the facile changing of the letters, numbers, pictures, and other exhibited representations.

(2) Description of Related Art

Commercial enterprises often employ one or more signs with at least one panel, preferably semi-rigid, that receives a display and that can withstand forces of many kinds, such as that which occurs from pressing or pulling. They should also remain generally intact notwithstanding exposure to the elements such as the wind. A display may include, in addition to those generally encountered by the public, a body that receives markings by any means, such as printed ink, intended to be viewed by passers-by. They often display messages of interest such as marketing advertisements.

The rigidity of signs has previously been achieved by several methods. These include the use of a frame to which display panels attach as disclosed an U.S. Pat. No. 3,374,566 to Snediker. Alternately, adjustable arms may provide opposing support to display panels as shown in U.S. Pat. No. 7,107,713 to Simson. However, these methods often provide direct support only to a small percentage of a display panel's surface area rather than adequate direct support for the entire panel. The disclosures of these patents are incorporated by reference.

Additionally, quickly and easily changing the display panel of a sign may prove not only desirable but particularly important if the sign sits outside and remains subject to relatively harsh weather conditions. In this instance, the person changing the display panel will rush to accomplish the task as quickly as possible. Or, where the person changing the display panel may lack mechanical skills and finds it difficult to manipulate even simple hardware such as screws, nuts, and bolts.

The Snediker patent, mentioned above, attempts to solve this problem but proves problematic because it discloses display panels with letters and numbers printed directly on it which hinders changing the representations quickly. U.S. Pat. No. 4,583,311 to Hosey attempts to solve this problem with a changeable loop form of sign; however, it includes a large amount of hardware that must be removed and replaced in order to accomplish the change of the display-panel. The Simson patent, also referenced above, attempts to address the problem with a support bracket that grabs a display panel and releases it when necessary. However, it again using extensive hardware along with the display panels in order to effectuate the change. The disclosure of the Hosey patent, as well as the others, is also incorporated by reference.

The sign industry can benefit from a sign that does not damage existing business equipment, such as an existing outdoor menu to which the sign may attach. The currently used signs attach to existing business equipment, such as outdoor menus found at restaurants, by the use of sheet metal screws, nuts and bolts, or similar attaching hardware. Attachments of this type invariably pierce the existing business equipment, which is often hollow and contains sensitive items within such as electrical lighting. Piercing in this manner may also allow rain to enter the existing business equipment. In fact, these signs that pierce existing business equipment can void a warranty on the existing signs.

Accordingly, the search continues for a sign that can provide support against great forces but can receives a display panel that is easily and quickly interchangeable. Further, it should attach to existing business equipment without damaging that equipment.

### SUMMARY

In light of the above, an improved sign should typically have the capability of withstanding a large force, such as strong winds, and which receives and supports a display by providing direct support to a large surface area of the display. Further the sign may provide for the quick and facile interchangeability of its display. For example a magnetic banner display can be easily rolled onto a sheet metal face of the sign without the use of any further attaching hardware. In particular, a sign may include a display with many differently shaped markings such as advertisements depicting a soda, hamburger, and fries, and can be included without changing the shape of the display itself.

As a further possibility, a sign may have a construction that includes several panels. This decreases the cost of delivering the sign to its destination as compared to a sign of the same size but with a single-panel construction.

As a further possibility, a sign may attach to existing business equipment, such as outdoor menus, by a method that does not pierce the existing equipment. For example, the sign may clamp onto the existing equipment.

In particular, a sign may include at least one panel preferably made of sheet metal. The sign accepts a display with markings, such as printed advertisements, for a drive-through restaurant's promotional menu items. The sign can attach to existing business equipment, such as an outdoor menu found in a traffic corridor of fast-food restaurants without piercing the existing business equipment's shell. It also protects the display from wind and provides for a quick and easy change of the display, for example by magnetically attaching the display panel without additional attaching hardware.

As one possibility, the display panel may take the form of a planar support surface. Alternatively, the support surface may assume a non-planar configuration. The display surface may include several panels. In this case, each of the separate panels may take the form of a planar support surface, a non-planar support surface, or combinations of the two. These several panels can provide a continuous combined support surface, or they can present an interrupted support surface.

Further, the display may have a mounting surface composed of a magnetic material which, of course, produces a magnetic field. Further, the majority of the mounting surface may, on occasion, include the magnetic material. In this case, the magnetic mounting surface produces a substantially continuous magnetic field throughout the entire surface. The mounting surface can connect securely to the support surface by bonding magnetically across the majority of the support surface.

The mounting surface can assume either a planar and or a non-planar configuration. It can also be semi-rigid and shaped to conform to the support panel. Some mounting surfaces, including magnetic examples, may have a flexible construction. This allows them to conform to one or more support surfaces having various shapes, including both planar and non-planar configurations. Further the same flexible mounting surface can attach to both planar and non-planar support surfaces without undergoing modification. In particular, a flexible magnetic mounting surface can conform to a variously-shaped support surface and can bridge gaps and other inconsistencies occurring in the support surface. This can include areas where a number of support surfaces intersect. The flexibility of a magnetic mounting surface allow it to conform to support surfaces. This improves the magnetic connection between the two surfaces because of the close proximity between them.

The display, or mounting, surface may have a shape that closely matches the support surface. Alternately, the display's shape may diverge substantially from that of the support surface in useful ways. For example, a support surface may have the shape of a simple rectangle to facilitate its manufacture. Yet that rectangular surface can support a variety of differently-shaped displays, such as those with a shape to replicate a company logo or trademark, to project a desired figure, or to conform to the shape of readable text. Support surfaces with various shapes may provide similar utility. Further, the display can include cut-outs that may expose portions of an underlying support surface. The display can also have a configuration that conforms to the support surface in some regions and diverges in other areas. Nonetheless, the display and support surface characteristics discussed above enable various displays to easily and quickly connect to differing support surfaces. In use, displays can be attached and detached frequently to facilitate changing advertising efforts, time-dependent announcements, and other uses.

Accordingly, as a one object, the present invention provides an apparatus for converting an exterior menu stand used by fast food restaurants, often seen in drive-through lanes. This apparatus may include at least one semi-rigid magnetic sheet with a bottom edge that can fit into a channel portion on the exterior menu stand.

As a further object, the present invention provides an apparatus that allows its mounting to the front side of an exterior menu stand and can include at least one stabilizing rod to keep it from swaying in the wind or moving from its installed, substantially vertical plane. The stabilizing rod can have a stand end attached to the back side of the exterior menu stand to receive firm support. It may also have a sheet end, attached to a back side of at least one magnetic sheet.

As an additional object, the present invention provides an apparatus that receives a second flexible magnetic sheet with a printable side containing a graphic, such as an advertisement. This second magnetic sheet may magnetically attached to the first magnetic sheet. Its bottom edge may fit into the channel in the exterior menu stand.

Further, the present invention may provide an apparatus with at least one magnetic sheet having only first and second members. The first member may have a first bracket for mounting it to a top side of the exterior menu stand. Similarly, the second member may include a second bracket for mounting it to the top side of the menu stand. The first member may then possess a plurality of bolts fixedly attached to it and positioned at a substantially right angle to a plane of that member. The second member may then have a plurality of holes passing through it. The first and second members may sit alongside each other such that the bolts align with and pass through the holes in the latter. A number of nuts cooperate with the bolts to fixedly attach the second member to the first member. The invention can also have a third, flexible magnetic sheet having a third printable side. This printable side can include a printed graphic. It can be magnetically attached to the first magnetic sheet, and its bottom edge can also fit into a channel in the exterior menu stand.

The present invention can also possibly convert the advertisement space attached to the top portion of an exterior menu board located in drive-thru lanes of fast food restaurants. Thus, it provides advertisement space, which can be curved, to the top of exterior menu boards.

As a further object, the present invention presents an alternative to existing menu board top advertisement spaces by providing a magnetic surface onto which may be rolled magnetic sheet advertisements or other graphics.

As an additional object, the present invention acts as an apparatus capable of displaying graphics printed on magnetic sheets.

Further, the present invention may provide longer lasting space for placing a magnetic advertisement sheet. Further, it can replace corrugated plastic sheet menu-board advertisement toppers

As a further object, the present invention may provide a menu-board top for advertising constructed of a semi-rigid material such as thin sheet metal.

The present invention may also find use as an apparatus mounted to the top of a an exterior menu board and include a space for presenting images to the public. These might appear on menus found in the drive-through lanes of fast food restaurants.

The present invention may also convert existing menu board advertising stands. It can even go so far as to entirely replace such existing menu board stands.

A method of converting a sign to incorporate magnetically held information may include first mechanically coupling to a first support portion a first set of information to form a first sign portion. Then, to add easily removable sign portions, the method proceeds by magnetically and removably coupling a second set of information to a second support portion to form a second sign portion. Lastly, to complete the process, the first and second sign portions are retained to each other with a holder in a substantially fixed spatial relationship.

### BRIEF DESCRIPTION OF THE FIGURES

FIG. 1 gives a top, left, front isometric view of a sign having a replaceable magnetic panel and a support attached to an outdoor menu.

FIG. 2 provides a top, left, rear isometric view of the sign FIG. 1 having a magnetic portion attached by a clamp to an outdoor menu.

FIG. 3 provides an enlarged view of the circled section 12 of FIG. 2 showing the clamp that holds the magnetic sign to the underlying sign.

FIG. 4 gives a front observational view of a second apparatus for converting an exterior menu stand used by fast food restaurants.

FIG. 5 shows, in a front elevational view, a further apparatus for converting an exterior menu stand often used by fast food restaurants.

FIG. 6 provides a front, top, left isometric view of an additional apparatus for converting an exterior menu stand often used by fast food restaurants.

FIG. 7 gives an enlarged view of the circled portion 40 of the sign of FIG. 6.

### DETAILED DESCRIPTION

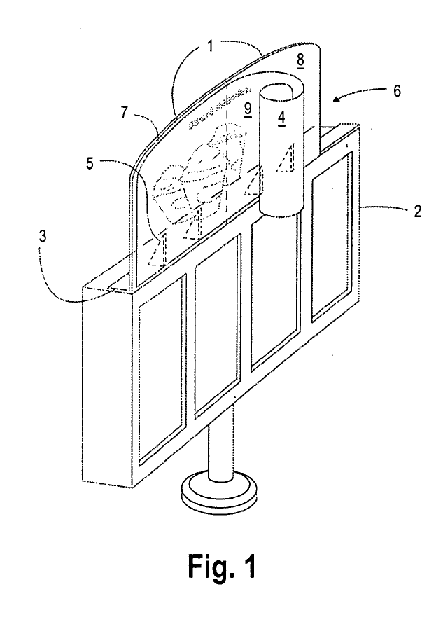

The sign generally designated at 6 in FIG. 1 allows for the easy changes of display advertisements. The two panels 1 are positioned side-by-side. The panels 1 form a support surface 8 upon which is attached the magnetic banner 7 with the image surface 9 and the mounting surface 4 that attracts the support surface 8 of the panels 1. One of the panels 1 is attached at an angle to a base 3. The base 3 is attached to the menu stand 2. A brace 5 is attached to the base 3 and a panel 1, thereby limiting relative motion between the panel 1 and the base 3.

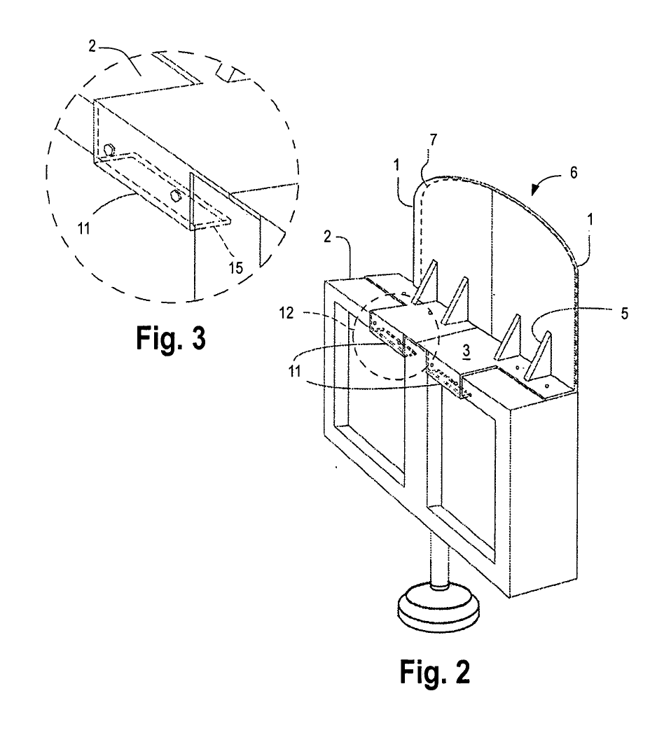

FIG. 2 shows the sign 6 of FIG. 1 as viewed from the rear. The brace 5 is attached at one end to the base 3 and at another end to the backside 10, of one of the panels 1. The sign 6 is attached to the outdoor menu 2 by the clamps 11 which does not penetrate the outer skin of the menu 2.

FIG. 3 shows in greater detail one of the clamps 11 holding the sign 6 of the present invention to the outdoor menu 2. As seen there, the clamp 11 has the lower lip 15 which holds onto the sign 2 without penetrating the outer skin of the menu 2.

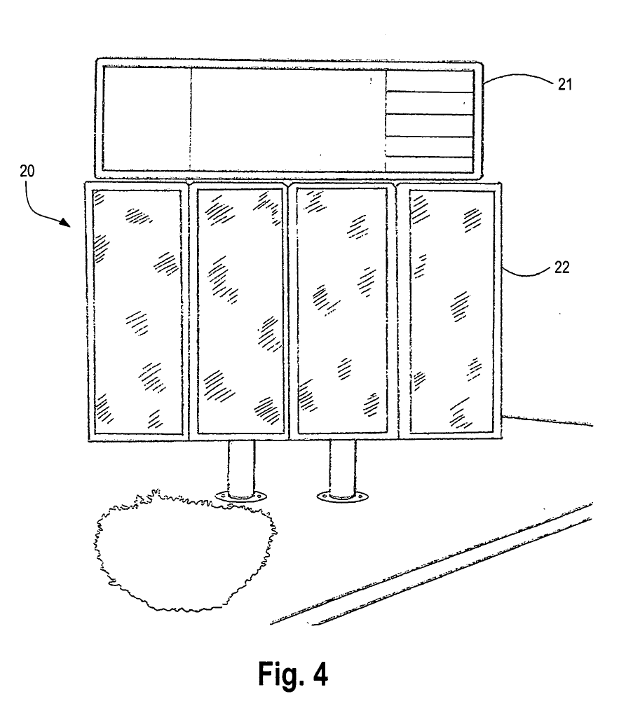

A second sign generally at 20 appears in FIG. 4 and results from the conversion of an exterior menu stand used, for example, by fast food restaurants. As shown there, the apparatus 21 for converting an exterior menu stand used by fast food restaurants mounts in its completed state to the exterior menu 22.

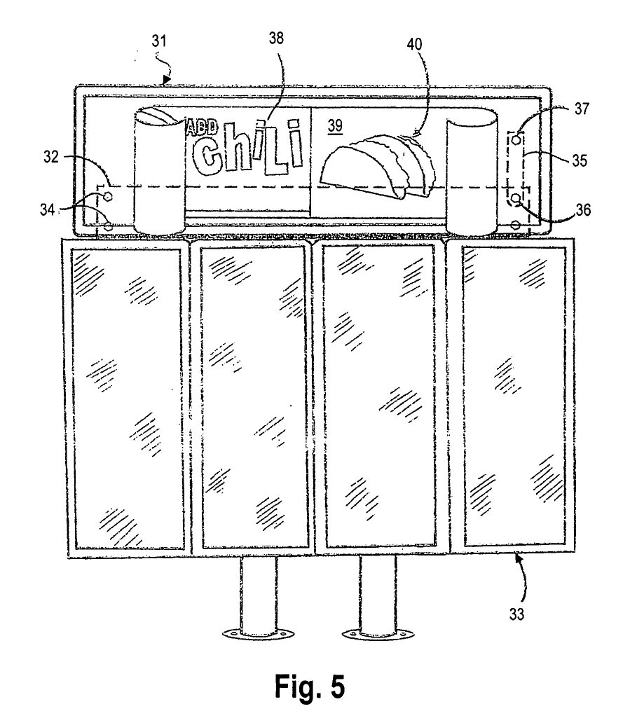

A further apparatus for converting an exterior menu stand used, for example, by fast food restaurants appears generally at 31 in FIG. 5. The converting apparatus 31 connects to the exterior menu stand generally at 33. Specifically, the apparatus 31 attaches to the bracket 32 of the menu stand 33 using the bolts and nuts 34. The stabilizing arm 35 includes the lower end 36, which attaches to the bracket 32 connected to the exterior menu stand, and the upper, or sheet end 37 attached to the apparatus 31 that converts the exterior menu stand 33 used by fast food restaurants. The magnetic sheet 38 with the printable side 39 receiving printing graphic designs 40 is rolled onto and attaches to the converting apparatus 31.

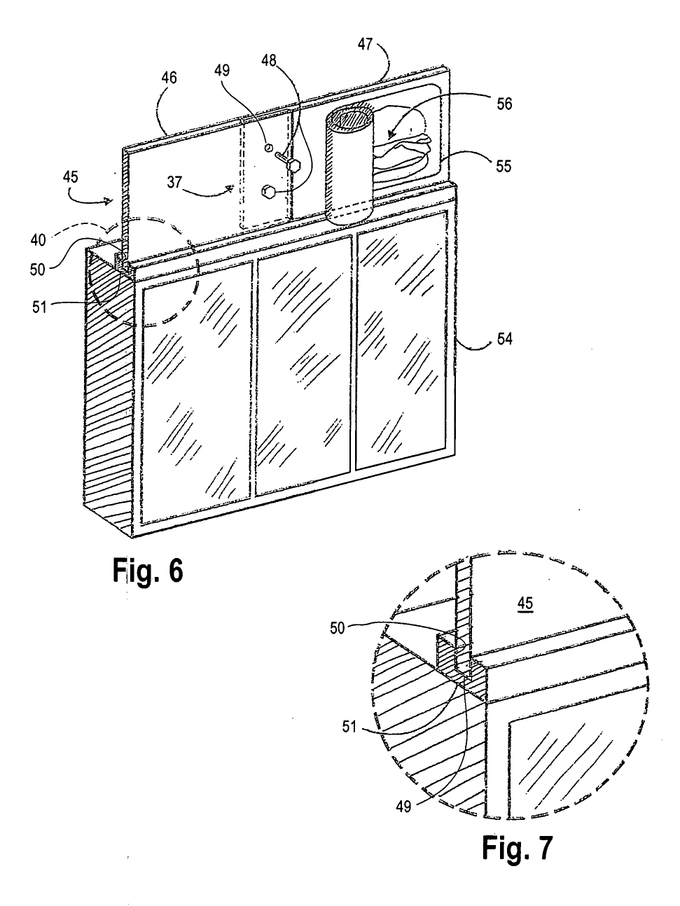

A fourth converting apparatus appears generally at 45 in FIG. 6 and includes the left member 46 and the right member 47. The left member 46 has the bolts 48 that align with the holes 49 on the right member 47 and fasten the two members 46 and 47 together using nuts that cooperate with the bolts 48. As seen in the expanded view of FIG. 7, the bottom edge 49 of the apparatus 45 fits into the channel 50 formed in the runner 51 of the exterior menu stand 54. The magnetic sheet 55 printed with the graphic design 56 is rolled onto and attaches to the converting apparatus 45.

What is claimed is:

1. A sign comprising:
A. a first sign portion having a first support portion and a first set of information mechanically coupled to said first support portion;
B. a second sign portion having a second support portion and a second set of information magnetically and removably coupled to said second support portion;
C. a holder, coupled to said first sign portion and to said second sign portion for retaining said first and second sign portions to each other in a substantially fixed spatial relationship relative to each other.

2. The sign of claim 1 wherein said holder retains said second sign portion above said first sign portion.

3. The sign of claim 1 wherein said second support portion includes a substantially smooth ferromagnetic surface and a substantially smooth sheet of magnetic material having graphic material adhered to one side.

4. The sign of claim 3 wherein said holder retains said second sign portion above said first sign portion.

5. The sign of claim 3 wherein said ferromagnetic surface includes a nonflat segment and sat least part of said magnetic sheet adheres to said nonflat segment.

6. The sign of claim 5 wherein said second sign portion has a shape other than rectangular.

7. The sign of claim 6 wherein said holder includes a clamping portion affixed to one of said first and second sign portions for holding onto the other of said first and said second sign portions.

8. The sign of claim 7 wherein said clamping portion is removable from said other of said first and second portions.

9. The sign of claim 8 wherein said clamping portion is affixed to said first sign portion and clamps on to said second sign portion.

10. The sign of claim 9 wherein said clamping allows the removal of said second sign portion from said first sign portion.

11. The Sign of claim 10 wherein said clamping portion is affixed to said second sign portion and clamps onto said first sign portion without penetrating the surface of said first sign portion.

12. The sign of claim 9 wherein said clamping portion is removable from said other of said first and second portions.

13. The sign of claim 5 wherein said clamping portion affixes said second sign portion to said first sign portion without penetrating the surface of said first sign portion.

14. The sign of claim 1 wherein said second set of information includes a plurality of substantially smooth sheets of magnetic material each having a portion of said second set of information.

15. The sign of claim 14 wherein at least one of said sheets of ferromagnetic material has an outer perimeter that is nonrectangular.

16. The sign of claim 15 wherein said second support portion includes a plurality of ferromagnetic support surfaces and wherein at least one of said support surfaces has a nonflat surface.

17. The sign of claim 15 wherein at least ONE OF SAID SHEETS OF said sheet of magnetic material is substantially flexible.

18. The sign of claim 14 wherein said second support portion has a substantially flat area and said substantially smooth sheet of magnetic material having graphic material adhered to one side is adhered to said substantially flat surface with said graphic material on the side of said sheet opposite from the side adhered to said substantially smooth surface.

19. The sign of claim 18 wherein said clamping portion is affixed to said first sign portion and clamps on to said second sign portion.

20. The sign of claim 19 wherein said clamping allows the removal of said second sign portion from said first sign portion.

21. The Sign of claim 20 wherein said clamping portion clamps onto said first sign portion without penetrating the surface of said first sign portion.

22. The sign of claim 14 wherein at least one of said support surfaces has a nonflat surface.

23. The sign of claim 22 wherein said sheet of magnetic material is substantially flexible.

24. The sign of claim 1 further including a retaining device holding said first and second sign portions and said holder at a location substantially fixed relative to the ground.

25. The sign of claim 21 wherein said holder retains said second sign portion above said first sign portion.

26. The sign of claim 25 wherein said holder includes a clamping portion affixed to one of said first and second sign portions for holding onto the other of said first and said second sign portions.

27. The sign of claim 9 further including a base coupled to said first sign portion for holding said first sign portion at a fixed location above a generally horizontal surface.

28. The sign of claim 3 wherein said second sign portion has a shape other than rectangular.

29. The sign of claim 3 wherein said ferromagnetic surface is non-planar.

30. The sign of claim 29 wherein said sheet of magnetic material is substantially flexible.

31. The sign of claim 30 wherein said clamping portion affixes said second sign portion to said first sign portion without penetrating the surface of said first sign portion.

32. The sign of claim 7 wherein said first sign portion includes a retaining device that holds graphic sign elements next to said translucent surface on the side of said light and said translucent surface permits the viewing of said graphic sign elements through said translucent surface.

33. The sign of claim 3 wherein said first sign portion includes an interior area, a translucent surface over said interior area, and a light visible through at least part of said translucent surface.

34. The sign of claim 1 wherein said holder includes a gripper, coupled to said holder, for attaching said ferromagnetic surface to a structure at an elevation above the level of the surface surrounding said structure.

35. The sign of claim 34 wherein said the exterior perimeter of said magnetic sheet has a shape different from any of said ferromagnetic panels.

36. The sign of claim 1 wherein said clamping portion affixes said second sign portion to said first sign portion without penetrating the surface of said first sign portion.

37. A method of converting a sign comprising:
A. mechanically coupling to a first support portion a first set of information to form a first sign portion;
B. magnetically and removably coupling to a second support portion having a second set of information to form a second sign portion;
C. retaining with a holder said first and second sign portions to each other in a substantially fixed spatial relationship relative to each other.
